(19) United States
(12) Patent Application Publication
(10) Pub. No.: US 2025/0249470 A1
(43) Pub. Date: Aug. 7, 2025

(54) Liquid Sprayer

(71) Applicant: Robert Bosch GmbH, Stuttgart (DE)

(72) Inventors: Ramon Tam, Buffalo Grove, IL (US); Tiffany Kurko, Chicago, IL (US)

(21) Appl. No.: 19/034,706

(22) Filed: Jan. 23, 2025

Related U.S. Application Data
(60) Provisional application No. 63/549,698, filed on Feb. 5, 2024.

(51) Int. Cl. B05B 9/08; B05B 12/00

(52) U.S. Cl. CPC B05B 9/0861; B05B 12/006

(57) ABSTRACT

A modular, battery powered and portable liquid sprayer includes a supply tank assembly, a base assembly and a hose assembly. The supply tank assembly includes a supply tank that holds a liquid to be sprayed and a pump. The base assembly is selectively and detachably coupled to the supply tank assembly. A pressure transducer housed in the supply tank interacts mechanically with the base to activate a microswitch that will turn the motor on or off, controlling flow of liquid to the hose assembly.

### BACKGROUND

Hand-held (e.g., portable), powered liquid sprayers are used to spray or otherwise discharge a liquid agent onto an object or a surface. Powered liquid sprayers may include a liquid supply tank that stores liquid to be sprayed and a power unit that receives liquid from the tank and directs the fluid to a spray wand that terminates in a nozzle. Sprayers typically transfer the liquid from the tank to the object using a pump, a vacuum, or any other device that can create a pressure differential between the reservoir and a region outside the reservoir, thereby urging the liquid to the region outside the reservoir. The liquid can be any of any type including water, pesticides, fertilizers, insecticide, termiticide, germicide, or other chemical agents.

### SUMMARY

The sprayer is a portable, modular, battery powered liquid delivery system that requires no manual pumping. The sprayer is portable (e.g., the sprayer can be lifted by the user and transported and/or operated while lifted). The modular design of the sprayer consists of three components, including a supply tank assembly, a base assembly and a hose assembly. The supply tank assembly includes a supply tank that holds a liquid to be sprayed and a pump. The base assembly is selectively and detachably coupled to the supply tank assembly. The supply tank assembly and base assembly may be attachable for example via buckles on the front and back of the tool.

The base assembly encloses and supports a motor, a power supply and control electronics. The power supply may be a battery that is removably coupled to the base assembly and is operable to supply power to the motor. The motor engages the pump upon assembly of the supply tank assembly with the base assembly and may be selectively activated by any type of pressure gage housed in the supply tank to mechanically trigger a microswitch housed in the base assembly.

The ability to separate the supply tank assembly from the base assembly allows the user to exchange supply tank assemblies for use with a single base assembly. This feature advantageously prevents cross-chemical contamination and permits the use of various tank assemblies for differing applications while continuing to use the same powered base. In addition, the ability to separate the supply tank assembly from the base assembly allows the user to replace either the supply tank assembly or the base assembly at a lower cost compared to replacing the entire tool.

In some embodiments, the sprayer includes multiple supply tank assemblies for use with the base assembly. For example, the sprayer may include three types of four-gallon tanks, each tank being compatible with the powered base: a chemical tank, a water tank, and a concrete chemical tank. Each supply tank may be formed using materials compatible to the liquid to be stored therein.

The hose assembly is in fluid communication with the supply tank assembly. In addition, the hose assembly is movable relative to the supply tank assembly and is configured to be detachably connected at a proximal end to the supply tank. In some embodiments, the distal end of the hose assembly includes a wand. In other embodiments the distal end of the hose assembly includes a quick connector enabling connection to another device such as a power tool. In these embodiments, the sprayer serves as a water source for the device (power tool).

The motor receives power from the battery and drives the pump to supply water from the tank to hose assembly. A pressure transducer is disposed in the supply tank and is in fluid communication with the pump fluid outlet line. The pressure transducer is operable to mechanically actuate a switch disposed in the base assembly when a pressure of the pump fluid outlet line is at a predetermined fluid pressure, and a controller selectively drives the motor (and thus the pump) to transfer the liquid from the supply tank assembly based on a signal from the switch.

### BRIEF DESCRIPTION OF THE FIGURES

FIG. 1 is a rear perspective view of a liquid sprayer.

FIG. 2 is a front perspective view of the sprayer.

FIG. 3 is a cross-sectional view of the sprayer with the hose assembly omitted.

FIG. 4 is an enlarged view of the portion of FIG. 3 enclosed in broken-line box A illustrating the pressure switch including the pin of the pressure transducer protruding into the base assembly a distance d1.

FIG. 5 is an enlarged view of the portion of FIG. 3 enclosed in broken-line box A illustrating the pressure switch including the pin of the pressure transducer protruding into the base assembly a distance d2.

FIG. 6 is a schematic illustration of the components of the sprayer in which electrical connections are represented with solid arrows and mechanical connections are represented with open arrows.

FIG. 7 is a rear perspective view of the sprayer including an alternative embodiment hose assembly.

FIG. 8 is a front perspective view of the sprayer including an alternative embodiment hose assembly.

FIG. 9 is a flow diagram illustrating operation of the sprayer.

FIG. 10 is an enlarged view of alternative embodiment portion of FIG. 3 enclosed in broken-line box A illustrating an alternative embodiment pressure switch. In FIG. 10, the pin shown in a solid line represents a protrusion of the pin into the base assembly a distance d1, and the pin shown in a broken line represents a protrusion of the into the base assembly a distance d2.

### DETAILED DESCRIPTION

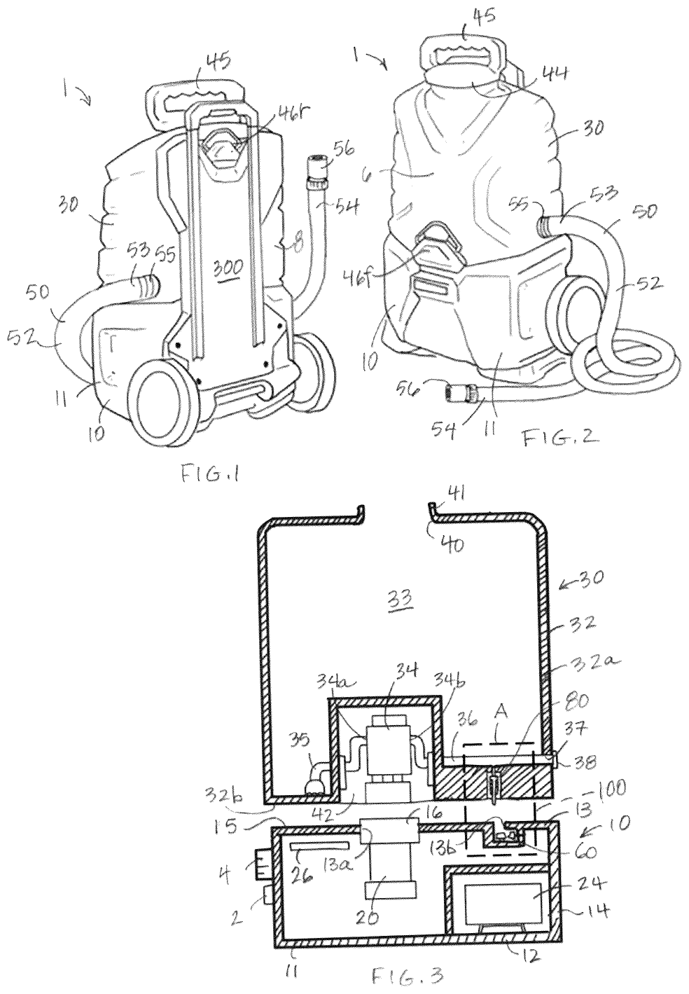

Referring to FIGS. 1-4, a portable, battery-powered liquid sprayer 1 is a modular device that includes base assembly 10, a supply tank assembly 30 that is detachably coupled with the base assembly 10, and a hose assembly 50 that is detachably connected to a supply tank 32 of the supply tank assembly 30. The base assembly 10 provides power for the sprayer 1 and includes a motor 20, a power supply 24 and a printed circuit board assembly (PCBA) 26 that includes a controller 27 and ancillary electronics. When the base assembly 10 is coupled to the supply tank assembly 30, the motor 20 is configured to drive a fluid pump 34 that is part of the supply tank assembly 30. The pump 34 receives fluid from the supply tank 32 and delivers it to the hose assembly 50 that is detachably secured to a fitting 38 of the supply tank 32. In some embodiments, the hose assembly 50 may be connected to a power tool (not shown), whereby the sprayer 1 may be used, for example, to deliver cooling fluid to a cutting blade of the power tool. In other embodiments, the hose assembly 50 may incorporate a hand-held wand assembly 200 configured to receive fluid and to emit and disburse the fluid as a spray. Details of the base assembly 10, the supply tank assembly 30 and the hose assembly 50 are described below.

The supply tank assembly 30 includes the supply tank 32, the pump 34, and pump fluid inlet and outlet lines 35, 36. In addition, the supply tank assembly 30 includes a pressure transducer 80 configured to respond to a fluid pressure of the pump fluid outlet line 36. The pressure transducer 80 is part of a pressure switch 100 used by the sprayer 1 in the control of motor operation.

The supply tank 32 is a generally hollow, rigid structure, and an internal space of the supply tank defines a reservoir 33 that receives a liquid to be sprayed. The liquid can be any number of liquid agents including pesticides, fertilizers, insecticide, termiticide, germicide, or other chemical agents.

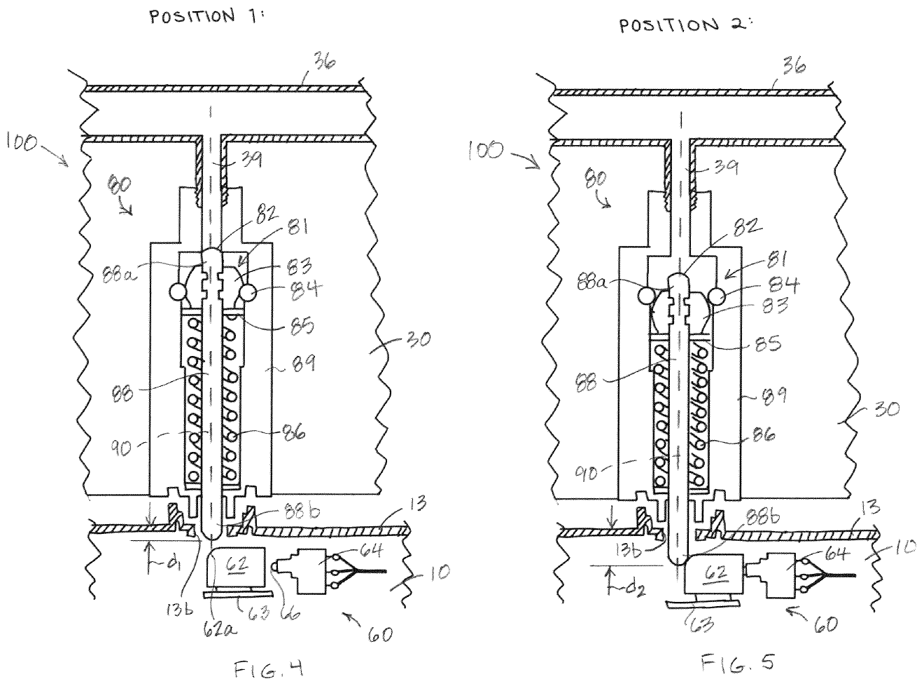

Although the supply tank 32 is illustrated here as having a generally rectangular shape, the supply tank 32 is not limited to any particular shape. The supply tank 32 is detachably coupled to and supported on an upper surface of the base assembly 10. References made herein to a relative direction such as upper, lower, above, below, top, bottom, over, under, front, rear, etc. are made with respect to the orientation of the sprayer 1 as shown in FIGS. 1 and 2 for purposes of description and are not intended to be limiting.

Because the supply tank 32 is detachable, it is possible to substitute one supply tank 32 for another on the base assembly 10. This interchangeability permits different chemicals, each contained in its own supply tank 32, to be used with the same base assembly 10. It also, or alternatively, permits supply tanks 32 of different sizes to be used with the same base assembly 10. In some embodiments, for example where the liquid to be sprayed is a corrosive chemical, the supply tank 32 may be formed of metal. In other embodiments, the supply tank 32 may be formed of plastic.

The supply tank 32 includes a fill opening 40 in an upper surface thereof. The fill opening 40 is surrounded by an upright annular projection 41 having an external thread. A lid 44 having a complementary internal thread may be secured to the projection 41, whereby by the fill opening 40 may be closed in a fluid-tight manner. In some embodiments, the lid 44 includes a handle 45. In some embodiments, the lid 44 includes a handle 45. In some embodiments, the lid 44 includes a relief valve (not shown). When the supply tank 32 is detached from the base assembly 10, the supply tank 32 may be carried by the handle 45.

A lower surface 32b of the supply tank 32 includes a recess 42 that is shaped and dimensioned to receive and support the pump 34. Thus, although the pump 34 is part of the supply tank assembly 30, the pump 34 is housed in a dry space defined between outer surfaces of the supply tank 34 and the base assembly housing 11.

The pump 34 may be double diaphragm pump, which may provide improved longevity in the presence of chemicals than other types of pumps. However, the pump 34 is not limited to being a double diaphragm pump, and the type of pump used may depend on the specific application. The pump 34 disposed in the recess 42 in such a way that the pump 34 is driven by an output shaft of the motor 20. For example, the pump 34 may be supported by the surfaces of the recess 42 so that the pump 34 may form a mechanical connection with the motor 20.

The pump 34 includes a pump fluid inlet line 35 that extends in a sealed manner between the pump inlet 34a and the supply tank reservoir 33 and a pump fluid outlet line 36 that extends between the pump outlet 34b and the fitting 38. In the illustrated embodiment, the pump fluid outlet line 36 passes in a sealed manner through the portion of the supply tank wall that defines the recess and through the reservoir 33 to attach to the fitting 38. In other embodiments, portions of the pump fluid outlet line 36 may be internal to the supply tank wall so that the pump fluid outlet line 36 does not pass through the supply tank reservoir 33.

The supply tank 32 has a tank outlet opening 37 in a side surface 32a thereof that receives the fitting 38 therein. The fitting 38 permits the hose assembly 50 to be detachably connected to the supply tank 32 in a sealed manner. For example, the fitting 38 may provide a threaded connection to the hose assembly 50. In other embodiments, the fitting 38 may provide a quick connector type fitting and/or may permit a swiveling connection. In still other embodiments, the fitting may provide a snap-fit connection or other known fluid-tight connection. When the hose assembly 50 is connected to the fitting 38, the fitting 38 permits fluid communication between the pump fluid outlet line 36 and a hose portion 52 of the hose assembly 50.

Referring to FIGS. 3-5, the supply tank assembly 30 includes a pressure transducer 80 configured to respond a pressure of the fluid in the pump fluid outlet line 36 and provide a mechanical indication when the pressure in the pump fluid outlet line is greater than a predetermined pressure. In the illustrated embodiment, the pressure transducer 80 includes a plunger 81 that is movable within a transducer housing 89 along a transducer axis 90. The plunger 81 is biased by a pressure spring 86 to a closed position in which a primary diaphragm 82 of the plunger 81 obstructs a fluid inlet channel 39. The fluid inlet channel 39 is formed in the wall of the supply tank 32 and connects an interior space of the transducer housing 89 with the pump fluid outlet line 36. The plunger 81 includes the primary diaphragm 82 which is provided at a first end 88a of a rigid pin 88. The plunger 81 includes a piston 83 that is fixed to the pin 88 at a location near the pin first end 88a. The piston 83 forms a fluid tight seal with an interior surface of the transducer housing 89 via an O-ring seal 84. The plunger 81 includes a secondary diaphragm 85 disposed on a side of the piston 83 opposite the primary diaphragm 82. The spring 86 extends between the secondary diaphragm 85 and an interior surface of the transducer housing 89. The pin 88 extends along a centerline of the spring 86 and is coaxial with the transducer axis 90. The pin 88 is sufficiently long that a second end 88b of the pin 88 protrudes beyond the spring 86 through an opening in the transducer housing 88.

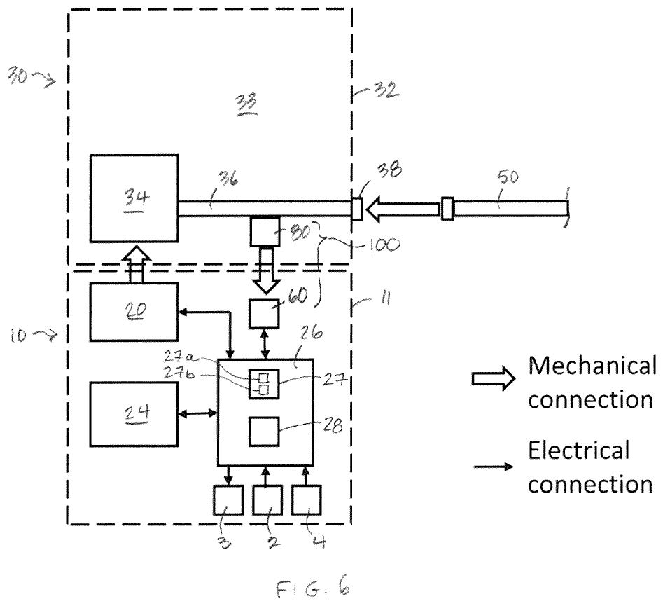

When a pressure of fluid within the pump fluid outlet line 36 is less than a predetermined pressure that corresponds to the spring force of the spring 86, the spring force of the spring 86 drives the plunger 81 along the transducer axis in a first direction, e.g., toward the fluid inlet channel 39 to an extent that the primary diaphragm 83 obstructs the fluid inlet channel 39 and the pin second end 88b protrudes from the transducer housing 89 a first distance d1 (FIG. 4). When the supply tank assembly 30 is coupled with the base assembly 10 and the pressure of fluid within the pump fluid outlet line 36 is less than the predetermined pressure, the pin second end 88b is disposed in a corresponding opening 13b of the housing 11 of the base assembly 10.

When a pressure of fluid within the pump fluid outlet line 36 is greater than the predetermined pressure (e.g., greater than the spring force of the coil spring 86), the spring 86 compresses and the plunger 81 including the pin 88 is driven along the transducer axis 90 in a second direction. The second direction is opposite the first direction, e.g., away from the fluid inlet channel 39. In this event, the pin second end 88b protrudes from the transducer housing 89 a second distance d2 that is greater than the first distance d1 (FIG. 5). When the supply tank assembly 30 is coupled with the base assembly 10 and the pressure of fluid within the pump fluid outlet line 36 is greater than the predetermined pressure, the pin 88 is disposed in a corresponding opening 13b of the housing 11 of the base assembly 10 and the pin second end 88b resides within the base housing 11 and actuates a switch assembly 60, as further discussed below.

Referring again to FIGS. 1 and 2, the supply tank 32 may include features that permit it to be detachably secured to the base assembly 10. For example, in the illustrated embodiment, the supply tank 32 is detachably connected to the base assembly 10 using metal buckles 46. In this example, a buckle 46 is provided on each of the front side 6 and the rear side 8 of the sprayer 1. The front buckle 46f is provided on the sprayer front side 6 at a location near the joint between the supply tank 32 and the base assembly housing 11. One of the male portion or the female portion of the buckle 46f may be provided on the supply tank 32, while the other of the male portion or the female portion of the buckle 46f may be provided on the base assembly housing 11. In addition, a rear buckle 46r is provided on the sprayer rear side 8 at an upper portion of the supply tank 32. One of the male portion or the female portion of the buckle 46r may be provided on the supply tank 32, while the other of the male portion or the female portion of the buckle 46 may be provided on the back frame 300, which is used to facilitate transport of the sprayer 1. The buckles 46 allow the supply tank assembly 30 to be selectively attached and detached from the base assembly 10 without requiring tools to be used.

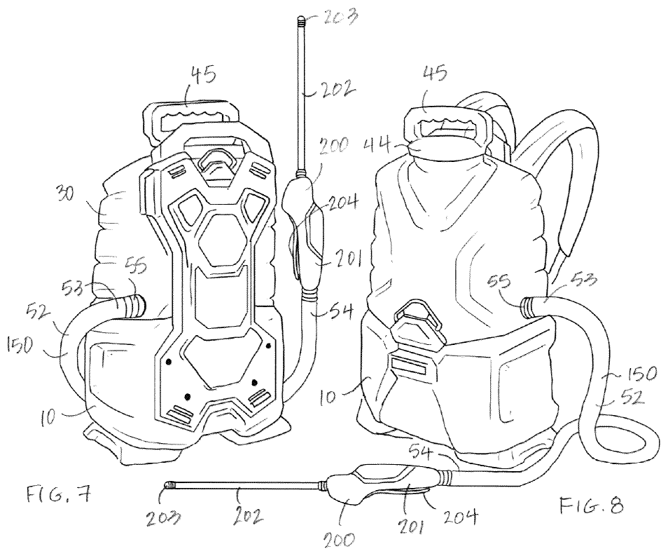

Referring FIGS. 1-3 and 6, the base assembly 10 is configured to underlie the supply tank 32 in such a way that the motor 20 forms a mechanical connection with the pump 34 and a pressure transducer 80 provided in the supply tank 32 forms a mechanical connection with a switch assembly 60 disposed in the base assembly 10, as discussed in detail below. The base assembly 10 includes a base housing 11 that encloses the elements of the base assembly 10. The housing 11 may include a base 12, a cover 13 that overlies the base 12, and a sidewall 14 that extends around a periphery of the base 12 and the cover 13 and joins the base 12 to the cover 13.

The upper surface 15 of the base assembly housing 11 (e.g., an outer surface of the cover 13) may include features that enhance proper positioning and/or location of the supply tank 32 relative to the base assembly 10 and/or that facilitate a reliable connection between these structures, including shaped surface structures (protrusions, rails, recesses, channels, etc.) that are complimentary in shape and or are configured to engage each other.

The cover 13 includes a first opening 13a, e.g., a motor output opening 13a that permits an output shaft of the motor 20 to pass through the base housing 11. The motor output opening 13a may be encircled by a collar 16 that receives and engages with a portion of the pump 34.

The cover 13 includes a second opening 13b, e.g., a transducer opening 13b that receives the pin 88 of the pressure transducer 80. The transducer opening 13 permits access to the switch assembly 60, which is supported by an interior surface of the base housing 11 in such a way that an actuator (e.g., a slider 62) of the switch assembly 60 is disposed in close proximity to the second opening 13b. In particular, the slider 62 is arranged and supported by the base housing 11 so that the slider 62 may be actuated by extension of the transducer pin 88 into the base housing 11 as occurs at a predetermined pressure of the pump fluid outlet line 36.

The housing 11 contains several of the working elements of the sprayer 10, including the motor 20, the switch assembly 60, the power supply 24 which may be a rechargeable battery and the PCBA 26. The PCBA 26 supports a controller 27, a battery monitoring system (BMS) 28 and other ancillary electronic components required for operation of the sprayer 1. In addition, the housing sidewall 14 supports an on/off switch 2 that controls an electrical connection between the battery 24 and the motor 20, a display or human machine interface (HMI) 3, and a fluid pressure level selector 4. In the illustrated embodiment, the fluid pressure level selector 4 is a rotary knob, but the sprayer 1 is not limited to this type of selector.

The motor 20 may be a brushless DC motor and is controlled by the controller 27 via an electrical circuit that includes the on/off switch 2 and the battery 24.

The switch assembly 60 is disposed in the base housing 11 and cooperates with the pressure transducer 80 to provide a pressure switch 100 used to selectively activate the motor 20. The switch assembly 60 includes a switch actuating element referred to as a slider 62 and a switch 64.

The switch 64 may be a push button switch having a protruding button 66 that translates relative to a housing of the switch 64 to provide switch actuation. In some embodiments, the switch 64 may be a microswitch. The term “microswitch” as used herein refers to a switch that is small in size (less than 16.4 k mm³) and very sensitive, requiring minimum compression to activate (activation force less than 5 N). The switch 64 is communicatively coupled to the controller 27.

In cooperation with the pressure transducer 80, the switch 64 outputs an electrical signal to the controller 27 to indicate when a pressure of the pump fluid outlet line 36 exceeds a predetermined pressure. In this regard, the switch assembly 60 cooperates with the pressure transducer 80 to provide a pressure switch 100. As used herein, the term “pressure switch” refers to a type of transducer that includes a pressure sensor and electronics that generate an electrical signal at a predetermined pressure level. As previously discussed, the transducer 80 includes a pressure sensor (plunger 81) and converts detected pressure into a translation of the pin 88 along the transducer axis 90. When the pin second end 88b is moved so that the second end 88b is at the second distance d2, the pin second end 88b contacts the slider 62. In particular, the pin second end 88b moves against a chamfered corner 62a of the slider 62, which drives the slider 62 to move along the rail 63 toward the switch 64. The transducer 80 and the switch assembly 60 are configured so that when the pressure in the pump fluid outlet line 36 is at the predetermined pressure, the pin 88 is moved axially, driving the slider 62 to actuate the switch button 66, whereby the switch 64 outputs a signal to the controller 27 indicating that the pressure of the pump fluid outlet line 36 is greater than the predetermined pressure. In other words, the switch 64 converts the translations of the pin 88 and slider 62 into an electrical signal indicating detection of the predetermined pressure in the pump fluid outlet line 36. Thus, the sprayer 1 is configured to permit motor operation based on pump outlet pressure as signaled by the pressure switch 100.

The battery 24 is configured to supply power to the motor 20 and the electronics supported on the PCBA 26 including the controller 27 and the BMS 28. In some embodiments, the battery 24 is non-detachable from the housing 11 and may be recharged via a housing plug (not shown). In other embodiments, the battery 24 is detachable from the housing 11 and may be removed from the housing 11 for charging and/or replacement via a door (not shown) provided in the housing 11. The BMS 28 may be configured to monitor the state of charge (SOC) of the battery 24 and provide an SOC signal to the controller 27. In turn, the controller 27 may control the display 46 to provide a representation of the SOC to the user during operation of the sprayer 1. As used herein, the term “battery” refers to a pack of individual cells; however, the monitoring and control functions of the BMS 28 are specifically applied to individual cells, or groups of cells called modules in the overall battery pack assembly.

In the illustrated embodiment, the BMS 28 is a software module of the controller 27. The BMS 28 may, for example, monitor the battery, provide battery protection, estimate the battery's operational state, optimize battery performance and/or report operational status of the battery to the controller 27.

The controller 50 is communicatively coupled with the pressure level selector 4 and the HMI 3. The pressure level selector 4 may be a manually-adjustable mechanical input device such as a rotary switch or a slide switch. The HMI 3 may be used, for example, to indicate the on/off status of the sprayer 1 and to provide a representation of the state of charge of the battery 24. The HMI 3 may be colored, non-colored (e.g., grayscale), or a combination of both. The HMI 3 may be implemented as any type of display including LCD, LED, VGA, OLED, SVGA, CRT, or any other alternative configuration known to one of ordinary skill in the art. In some embodiments, the HMI 3 may provide touch-screen functionality and the pressure level selector may be integrated into the HMI 3.

The controller 27 may also be communicatively coupled with various operational components of sprayer 1 as well, including, but not limited to, the motor 20 and the switch 64. As used herein, the term “communicatively coupled” may refer to a direct wired connection via for example electrically conductive signal lines, shared communication busses, or alternatively may refer to a wireless connection. Thus, controller 27 can receive information from these devices and selectively activate and operate the various operational components.

In some embodiments, controller 27 includes one or more memory devices 27a and one or more processors 27b. The processors 27b may be any combination of general or special purpose processors, CPUs, or the like that can execute programming instructions or control code associated with operation of the sprayer 1. The memory devices (i.e., memory) 27a may represent random access memory such as DRAM or read only memory such as ROM or FLASH. In some embodiments, the processor 27b executes programming instructions stored in memory 27a. The memory 27a may be a separate component from the processor 27b or may be included onboard within the processor 27b. Alternatively, the controller 27 may be constructed without using a processor 27b, for example, using a combination of discrete analog or digital logic circuitry (such as switches, amplifiers, integrators, comparators, flip-flops, AND gates, and the like) to perform control functionality instead of relying upon software.

In some embodiments, the controller 27 includes a network interface such that the controller 27 can connect to and communicate over one or more networks (not shown). The controller 27 may also include one or more transmitting, receiving, or transceiving components for transmitting and/or receiving communications with other devices communicatively coupled with the sprayer 1. Additionally, or alternatively, the transmitting, receiving, or transceiving components can be located off board controller 27. Generally, the controller 27 may be positioned in any suitable location throughout base assembly 10.

The various functions performed by the controller 27 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Referring to FIGS. 1 and 2, in addition to the base assembly 10 and the supply tank assembly 30, the sprayer 1 also includes the hose assembly 50. The hose assembly 50 is used by the operator of the sprayer 1 to direct fluid output from the sprayer 1 to the area to be sprayed.

In the embodiment illustrated in FIG. 1, the hose assembly 50 includes a hose portion 52 having a first end 53 and a second end 54 that is opposite the first end 53. The first end 53 includes a first connector 55 that is detachably connectable to the outer portion of the fitting 38 provided on the sidewall supply tank 32. For example, if the outer portion of the fitting 38 provides an outer thread, the first end 53 including the first connector 55 may have an internal thread configured to engage and form a sealed connection with the fitting outer thread. The first connector 55 is not limited to a threaded configuration. For example, the first connector 55 may be a quick connector such as a high pressure quick connector if required by the type of the fitting 38.

The hose portion second end 54 is opposed to and spaced apart from the first end 53 by the hose portion 52. The second end 54 includes a second connector 56 that enables the pump fluid outlet line 36 to be detachably connected to an external device such as a power tool (power tool is not shown). For example, the second connector 56 may have an internal or external thread configured to engage and form a sealed connection with a fitting of the external device. In another example, the second connector 56 may be configured to engage a high pressure quick connector to permit engagement with a counterpart connector of the external device.

The hose portion 52 may be a flexible tube that is configured to contain pressurized fluid. In addition, the first and second connectors 55, 56 and the hose portion 52 may be formed of a material or materials that are impervious to chemicals such as, but not limited to, pesticides, herbicides, fungicides, insecticides, fertilizers, and/or concrete-related chemicals such as curing and sealing chemicals, etcher, form oil, muriatic acid, xylene, etcetera.

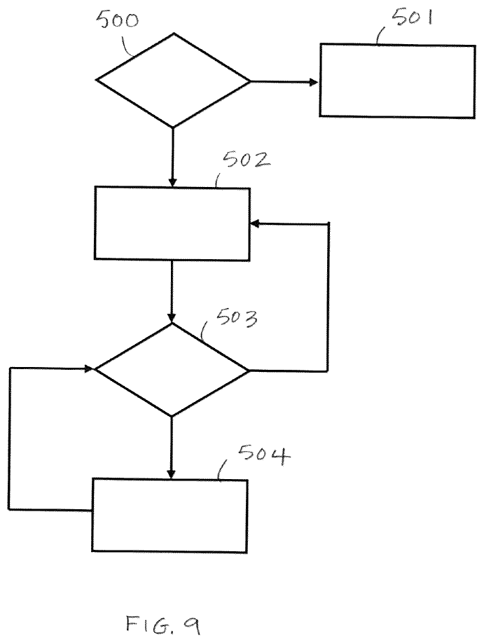

Referring to FIGS. 7 and 8, the sprayer 1 may include an alternative embodiment hose assembly 150. The alternative embodiment hose assembly 150 includes common elements to the hose assembly 50 shown in FIGS. 1 and 2, and common elements have common reference numbers. The hose assembly 150 differs from the previous embodiment in that the second connector 56 is replaced by a wand assembly 200 that detachably connects to the hose portion second end 54, receives fluid from the supply tank 32 via the hose portion 52 and is configured to selectively spray the received fluid. The wand assembly 200 includes a handle 201 that is joined to the hose portion 52 and a rigid, tubular wand 202 that protrudes from the handle 201. The wand 202 terminates in a spray nozzle 203 which may be adjustable to permit selection of a spray pattern. The handle 201 is sized and shaped to be gripped by the hand of an operator of the sprayer 1. The handle 201 includes a normally closed fluid control valve and a protruding trigger 204. The trigger 204 is configured to open and/or close the fluid passageway between the hose portion 52 and the nozzle 203 via the control valve. For example, the operator of the sprayer 1 may depress the trigger 204 to permit fluid to flow through the wand assembly 200.

In embodiments in which the wand assembly 200 is detached from the base fluid outlet line second end 64 and the hose assembly 50 is connected to a power tool using a quick connector, such connector may include a normally closed internal valve that is mechanically opened upon secure connection of the second connector 56 to the power tool. In addition, the power tool may include an internal valve that controls fluid flow through a fluid passageway of the tool.

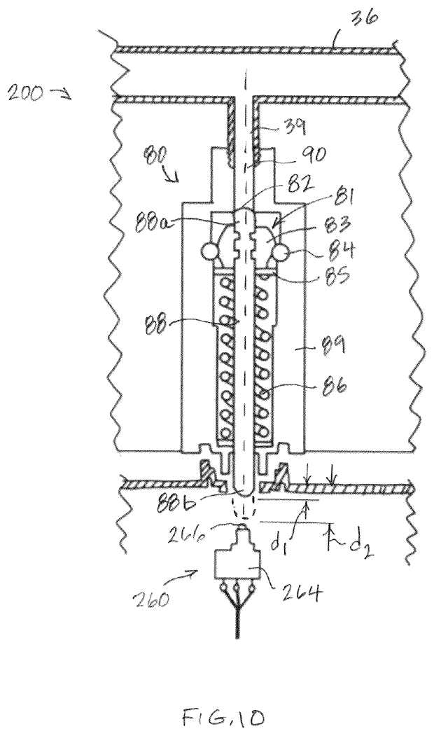

Referring to FIG. 9, operation of the sprayer 1 is as follows.

In step 500, when the on/off switch 2 is in the ‘off’ position, no energy is provided to controller 27 or other electrical components (e.g., the motor 20, the pressure sensor 34, the BMS 28, etc.) of the sprayer 1 by the battery 24 and the sprayer 1 is not operational (step 501).

If the on/off switch 2 is in the ‘on’ position, energy is provided to the controller 27 and other electrical components of the sprayer 1 (step 502). The controller 27 can then receive information from the BMS 28 such as SOC information and display that information on the display/HMI 3. In addition, the controller 27 can receive information from the pressure switch 100. The motor 20 receives power from the battery 24 and drives the pump 34 to draw fluid from the supply tank 32 and supply it to the base fluid outlet line 36. The motor 20 is permitted to run unless a high pressure state exists in the pump fluid outlet line 36.

In step 503, while the motor runs, the controller 27 monitors the status of the pressure switch, which gives an indication of the pressure in the pump fluid outlet line 36. If no signal is received from the switch 64 of the pressure switch 100, the controller 27 permits operation of the motor 20 to continue. If the controller 27 detects that a signal is received from the pressure switch 100, then operation moves to step 504.

In step 504, when the controller 27 detects that a signal is received from the pressure switch 100, the controller 27 operates to prevent power delivery from the power supply 24 to the motor 20, and the motor 20 stops operation.

If the trigger 204 of the wand assembly 200 is depressed, the wand control valve opens and fluid is permitted to flow through the wand 202 and exit the nozzle 203. In this situation, the pressure in the pump fluid outlet line 36 decreases and the pressure in this line becomes less than the predetermined pressure. The controller 27, which continues monitor the status of the pressure switch 100, will then permit power delivery from the power supply 24 to the motor 20, and the motor 20 resumes operation.

If the base fluid outlet line 36 is connected to a power tool via a quick connector, the fluid control mechanism of the connector permits fluid to flow to the power tool upon connection. However, the power tool may include an internal valve that controls fluid flow through the tool. If the internal valve is opened, the pressure in the pump fluid outlet line 32 remains below the predetermined pressure. In this case, the controller 27 permits power delivery from the power supply to the motor 20 and the pump 34 drives fluid to flow through the power tool.

Upon release of the trigger in the case of the wand assembly 200 or closure of a fluid valve of the power tool, the pressure in the pump fluid outlet line 36 increases to a pressure that is greater than the predetermined pressure, and the controller 27 stops power flow to the motor 20, which in turn stops operation of the pump 34.

If the hose assembly 50, 150 is not connected to the base assembly 10, the pressure in the pump fluid outlet line 36 is less than the predetermined pressure, for example zero. In this case, the motor 20 and pump 34 are allowed to operate until the reservoir 33 of the supply tank 32 is empty. In some embodiments, however, the pump 34 may include a check valve to prevent fluid flow in the event that the hose assembly 50, 150 is not connected to the base assembly.

Thus, in the sprayer 1, the pressure switch 100 is configured to respond to a predetermined fluid pressure of the pump fluid outlet line 36 and output a fluid pressure signal to the controller 27 when the fluid pressure is greater than the predetermined pressure. In addition, the controller 27 receives the fluid pressure signal and is configured to activate/deactivate the motor 20 based on the fluid pressure.

Referring to FIG. 10, an alternative embodiment pressure switch 200 is similar to the pressure switch 100 described above and common elements have common reference numbers. The pressure switch of FIG. 10 differs from the previous embodiment in that the pressure switch 200 includes an alternative switch assembly 260. The switch assembly 260 is disposed in the base housing 11 and cooperates with the pressure transducer 80 to provide the pressure switch 200 used to selectively activate the motor 20. The switch assembly 260 includes a switch 264 that is actuated via a magnetic force and is communicatively coupled to the controller 27.

For example, the switch 264 may include a protruding toggle 266 having magnetic properties of a first polarity. In addition, the pin second end 88b may be provided with magnetic properties. In the illustrated embodiment, the pin second end 88b has the same polarity as that of the protruding toggle 266. In some embodiments, the switch 264 may be a microswitch.

In cooperation with the pressure transducer 80, the switch 264 outputs an electrical signal to the controller 27 to indicate when a pressure of the pump fluid outlet line 36 exceeds a predetermined pressure. In this regard, the switch assembly 260 cooperates with the pressure transducer 80 to provide the pressure switch 200. The transducer 80 and the switch assembly 260 are configured so that when a fluid pressure is at or greater than the predetermined pressure, the pin 88 is moved toward the switch assembly 260 along the transducer axis 90. As the pin 88 moves from the first distance d1 to the second distance d2, the pin second end 88b approaches the protruding toggle 266 and the protruding toggle 266 is repulsed, resulting in actuation of the switch 264. Upon switch actuation, the switch 264 outputs a signal to the controller 27 indicating that the pressure of the pump fluid outlet line 36 is greater than the predetermined pressure. In other words, the switch 264 converts the translations of the pin 88 into an electrical signal indicating that a pressure in the pump fluid outlet line 36 is at or greater than the predetermined pressure. Thus, the sprayer 1 is configured to permit motor operation based on pump outlet pressure as indicated by the pressure switch 200.

Although the sprayer is described herein as consisting of three components (a supply tank assembly, a base assembly and a hose assembly), the sprayer is not limited to this configuration. For example, in some embodiments, the hose assembly is part of and/or made integral with the supply tank assembly, whereby the sprayer may consist of two components. In other embodiments, the base assembly may be part of and/or made integral with the supply tank assembly,, whereby the sprayer may consist of two components.

Although the supply tank assembly 30 is described as being mounted to an upper surface of the base assembly 10, the sprayer 1 is not limited to this configuration. For example, in other embodiments, the supply tank assembly may be coupled to a lower surface or side surface of the base assembly 10.

Selective illustrative embodiments of a portable power liquid sprayer are described above in some detail. It should be understood that only structures considered necessary for clarifying the portable power liquid sprayer have been described herein. Other conventional structures, and those of ancillary and auxiliary components of the portable power liquid sprayer are assumed to be known and understood by those skilled in the art. Moreover, while working examples of the portable power liquid sprayer have been described above, the portable power liquid sprayer is not limited to the working examples described above, but various design alterations may be carried out without departing from the device as set forth in the claims.

What is claimed:

1. A portable liquid sprayer, the sprayer comprising:
a base assembly including a base housing;
a supply tank assembly including a supply tank that is configured to store a liquid to be sprayed, the supply tank being detachably coupled to the base housing, the supply tank configured to be connected to a hose assembly;
a controller disposed in the base housing;
a motor disposed in the base housing, the motor being electrically connected to controller;
a battery disposed in the base housing, the battery being electrically connected to the controller;
a switch disposed in the base housing, the switch being electrically connected to the controller, the switch including an actuator movable between a first position and a second position;
a pump disposed in the supply tank, the pump configured to be driven by the motor and output fluid to the hose assembly via a pump fluid outlet line that is disposed inside the supply tank; and
a pressure transducer in fluid communication with the pump fluid outlet line, the pressure transducer operable to mechanically move the actuator between the first position and the second position when a pressure of the pump fluid outlet line is at a predetermined fluid pressure,
wherein
the controller is configured to permit the battery to supply power to the motor when the actuator is in the first position, and
the controller configured to prevent the battery from supplying power to the motor when the switch is in the second position.

2. The portable liquid sprayer of claim 1, comprising the hose assembly,
the hose assembly including a hose portion and a wand disposed at one end of the hose portion,
the wand including handle, a fluid outlet and a trigger, the trigger being manually operable to move between a first position relative to the handle in which fluid is permitted to flow out of the fluid outlet and a second position relative to the handle in which fluid is prevented from flowing out of the fluid outlet, and
wherein the hose assembly is free of electrical switches.

3. The portable liquid sprayer of claim 2, wherein the hose portion includes a mechanical fluid connector disposed at an end of the hose portion that is opposite the one end of the hose portion, the connector being selectively connectable to and detachable from the supply tank.

4. The portable liquid sprayer of claim 1, comprising
the hose assembly, the hose assembly including a hose portion having a first end and a second end that is opposite the first end, the first end including a first mechanical fluid connector and the second end including a second mechanical fluid connector,
wherein the hose assembly is free of a wand.

5. The portable liquid sprayer of claim 4, wherein the hose assembly is free of electrical switches.

6. The portable liquid sprayer of claim 4, wherein at least one of the first mechanical fluid connector and the second mechanical fluid connector is a quick connector.

7. The portable liquid sprayer of claim 1, comprising the hose assembly, wherein the hose assembly is selectively detachable from the supply tank.

8. The portable liquid sprayer of claim 1, wherein when the supply tank is coupled to the base housing, the pressure transducer extends from the supply tank into the base housing.

9. The portable liquid sprayer of claim 1, wherein when the supply tank is coupled to the base housing, the pressure transducer is capable of actuating the switch.

10. The portable liquid sprayer of claim 1, wherein the pressure transducer includes
a pressure sensor configured to detect a pressure of the fluid in the pump fluid outlet line and a pin configured to translate relative to the pump fluid outlet line based on the detected pressure of fluid in the pump fluid outlet line.

11. The portable liquid sprayer of claim 9, wherein the pin is configured to mechanically move the actuator from the first position to the second position upon detection of a predetermined fluid pressure in the pump fluid outlet line.

12. The portable liquid sprayer of claim 1, wherein the supply tank includes a supply tank mating surface that faces the base housing when the supply tank is coupled to the base housing,
the supply tank mating surface includes a first recess that is open to an exterior of the supply tank,
and
the pump is disposed in the first recess.

13. The portable liquid sprayer of claim 12, wherein the pump fluid outlet line has a line first end that is connected to an outlet of the pump, a line second end that is connected to a wall of the supply tank and a line midportion that is disposed between the line first end and the line second end, and
the line midportion is disposed inside the supply tank.

14. The portable liquid sprayer of claim 13, wherein the pressure transducer is in fluid communication with the line midportion.

15. The portable liquid sprayer of claim 1, wherein the base housing includes a base housing mating surface that faces the supply tank when the supply tank is coupled to the base housing,
the base housing mating surface includes a second vacancy that is open to an exterior of the base housing, and
the switch is disposed in the second recess.
